(19) United States
(12) Patent Application Publication
(10) Pub. No.: US 2021/0079698 A1
(43) Pub. Date: Mar. 18, 2021

(54) LOCKING SYSTEM AND USE THEREOF

(71) Applicant: Mavako ApS, Farum (DK)

(72) Inventor: Martin KONGSHAMMER, Herlev (DK)

(73) Assignee: Mavako ApS, Farum (DK)

(21) Appl. No.: 16/960,978

(22) PCT Filed: Dec. 21, 2018
(86) PCT No.: PCT/DK2018/050422

§ 371 Date: Jul. 9, 2020

(30) Foreign Application Priority Data
Jan. 10, 2018 (DK) PA 2018 70013
Jul. 27, 2018 (DK) PA 2018 70506

(51) Int. Cl. E05C 3/00; E05B 83/02

(52) U.S. Cl. CPC E05C 3/006; E05Y 2900/604; E05B 83/02

(57) ABSTRACT

The invention relates to a locking system for locking of a room that is provided with at least one and preferably two doors or openings, said locking system comprising a lock holder with a lock and two toothed wheels with teeth for insertion of a locking boom behind the door, and an arresting device that is connected to the lock for arresting the wheels in locked position. Furthermore, the invention relates to the use of the locking system for locking of for instance shipping containers.

The invention relates to a locking system for mounting at a door for looking a room that is provided with at least one door.

Furthermore, the invention relates to the use of such a locking system for locking transportable containers including shipping containers.

It is known to lock containers such as shipping containers with locking systems.

However, it has turned out that there are some drawbacks in relation to the prior art locking systems for shipping containers. Furthermore, none of them are sufficiently robust against violent attacks on the locks during attempts to break in.

One example of a known locking system for shipping containers is the locking system that is described in US 2012/0305565 A1, in which the locking system is installed on the centre post of a container front between the right and left door. Furthermore, bent edges, in which a slide can move, are welded thereon. A handle can from the outside push the slide downwards, whereby the slide pushes a locking boom down over two spigots, one on each facing end edge of the right or left door. In the same way, the slide can be moved upwards when the lock is in open position, so that the locking boom is lifted up. During opening, a blocking element that extends through the door is further ejected and moved away from the inner side of the door towards the outer side of the door. If the lock is locked this movement is hindered, and activation of the handle cannot move the slide, but instead a spring is deformed, the passive position of which corresponds to the closed position of the locking system. The lock that is described is only useful for containers with a centre post and it is not strong enough to resist a pull from a four wheel drive car.

It is therefore an object of the present invention to devise a locking system for locking of for instance shipping containers, and which is robust against attempts to break in with for instance a four wheel drive car.

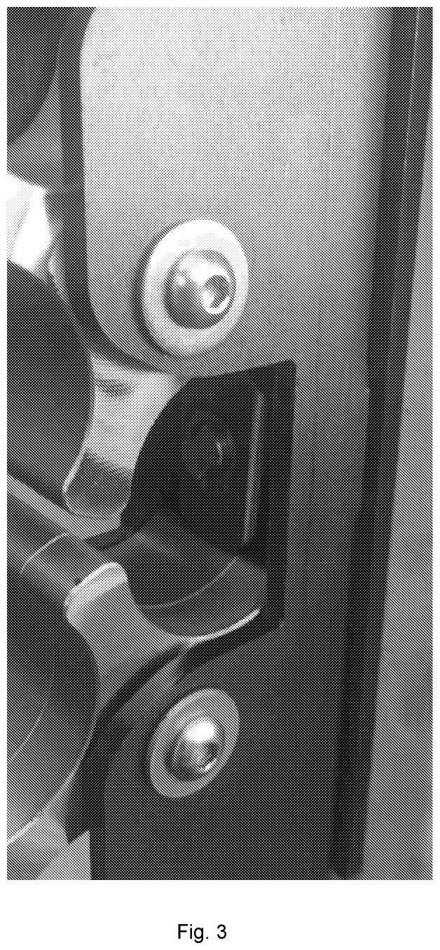

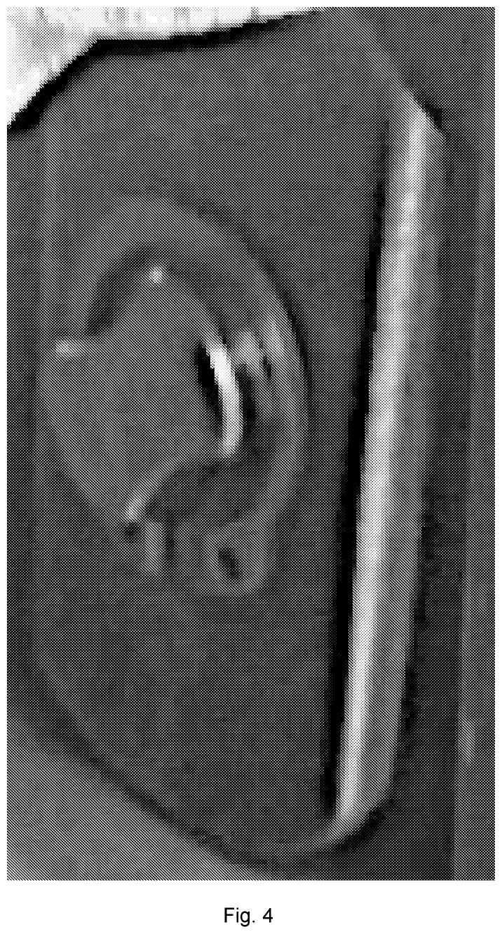

The object of the invention is met by means of a locking system of the type described in claim 1 which is characterized in that the locking system further comprises at least two toothed wheels that are mounted on the locking holder and are provided to be able to rotate around mutually parallel axes and to offer space between two sets of teeth on said at least two toothed wheels so that two teeth (6) are generally opposite one another so as to be able to lock said locking boom (8), and that the lock, the back side of which is shown in FIGS. 3 and 4, is further adapted to be mounted from the inner side and is connected to an arresting device, which is shown in the enlarged view of the arresting device and is shown in FIGS. 3 and 4, that can engage in the movement direction of the toothed wheels for rotating the teeth on the toothed wheels, and wherein a movable part on the lock is adapted to be able to rotate together with said arresting device, so that the toothed wheels (6) can rotate freely in the open position of the arresting device and not rotate in the locked, vertical position of the arresting device (see FIG. 3), so that a pull on said door or frame can be transferred to the locking boom (8) in the locked position.

Useful embodiments of the locking system are described in claims 2 to 9.

The use of an embodiment according to the invention is described in claim 10.

To make the invention easier understandable, some not limiting examples of embodiments will be described in details in the following, referring to the figures in which

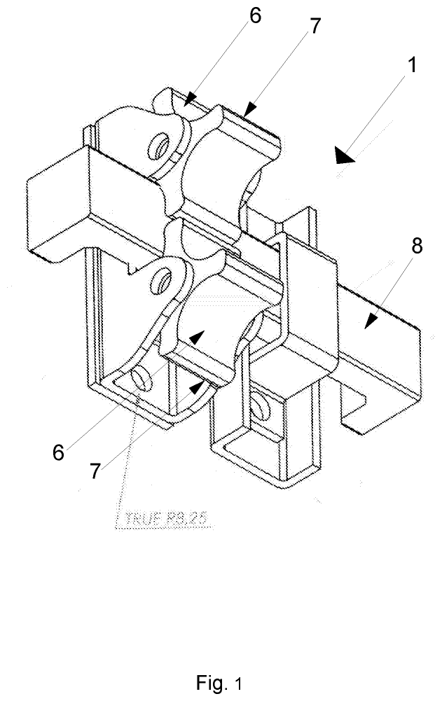

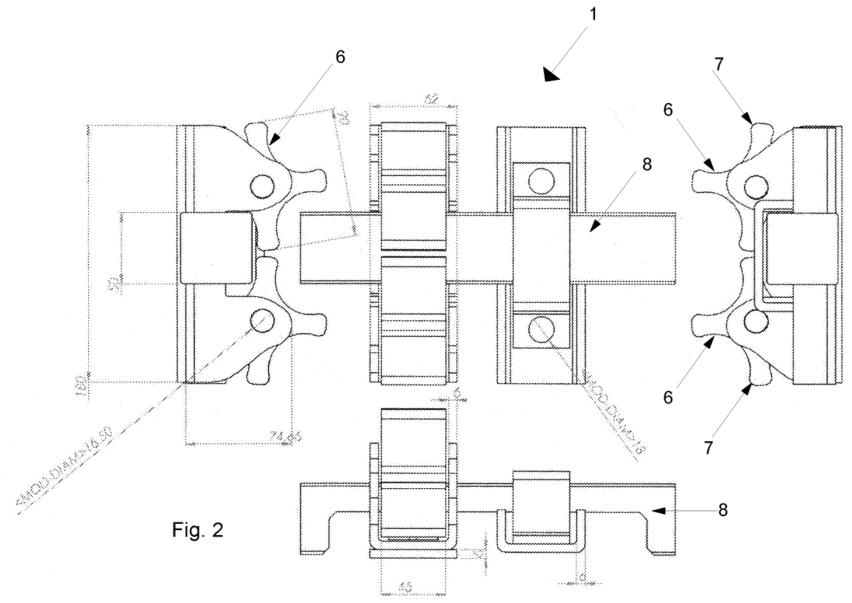

FIG. 1 shows the parts of FIG. 2, said parts being assembled and shown in a side view.

FIG. 2 is a technical drawing of an embodiment of the invention. It is like the example of FIG. 1 the same example as in FIGS. 3 to 13.

FIG. 3 shows an example of an embodiment of a locking system according to the invention, in which the two toothed wheels are shown in a locked position.

FIG. 4 shows an example of an embodiment of a locking device. The embodiment shown is the locking system that is shown in FIG. 3. This is in a vertical position.

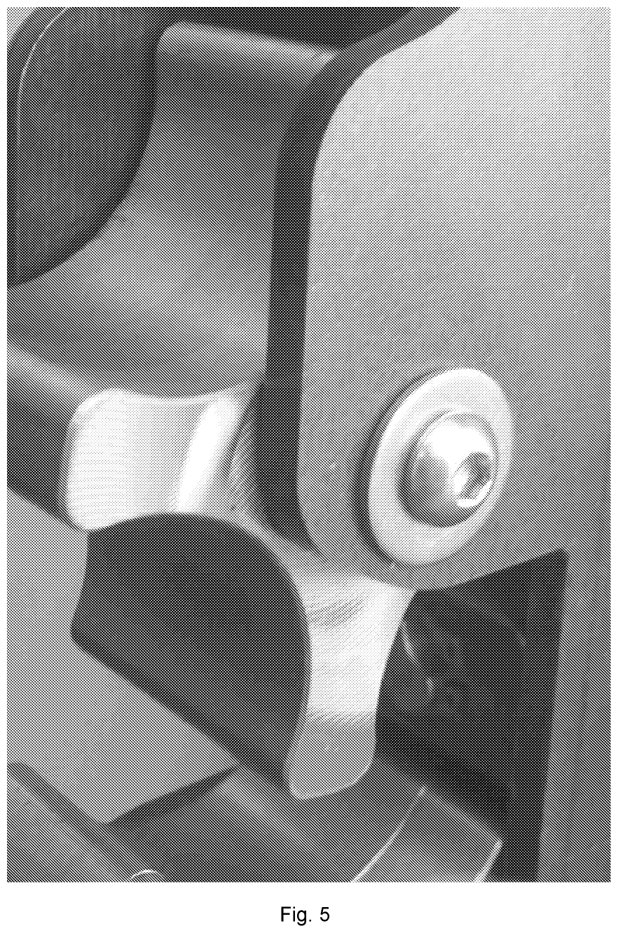

FIGS. 5 to 13 show other details of the example of FIG. 3.

FIG. 5 shows the embodiment of FIG. 3, in which the arresting device is in a horizontal, open position.

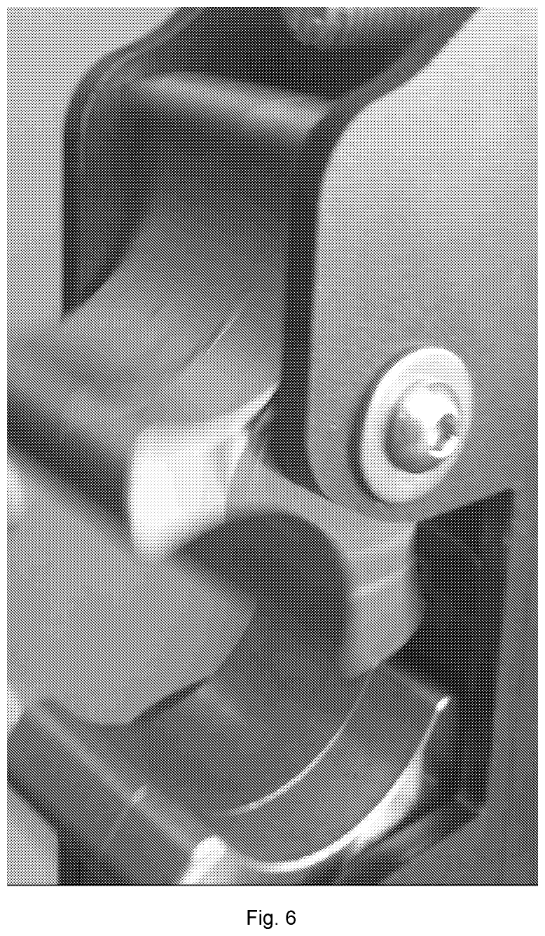

FIG. 6 shows that the toothed wheels can rotate when the arresting device is in a horizontal, open position.

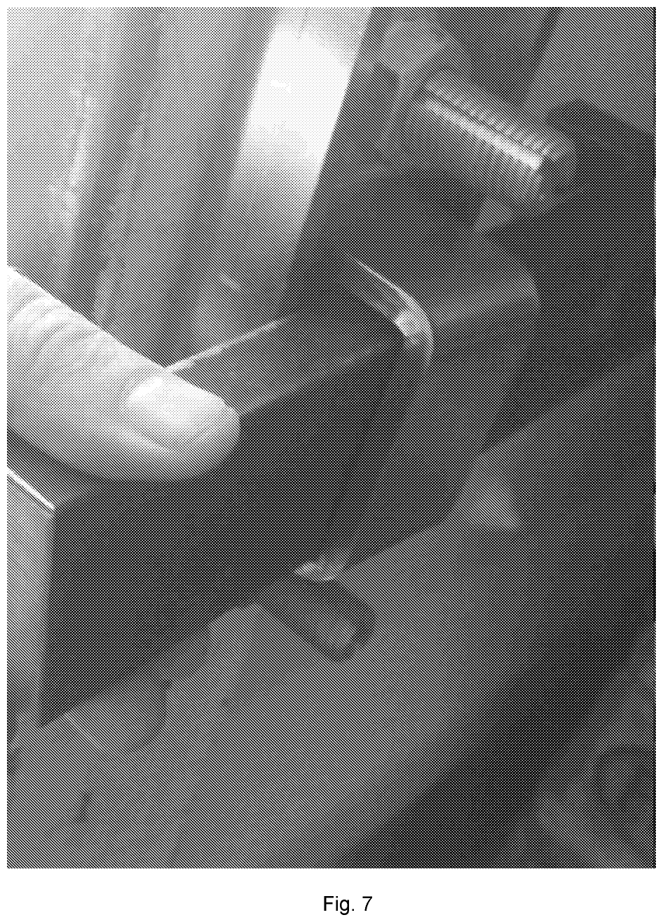

FIG. 7 shows a locking boom permanently mounted on the back side of a container door that in this case is one of the doors of the container in FIG. 1.

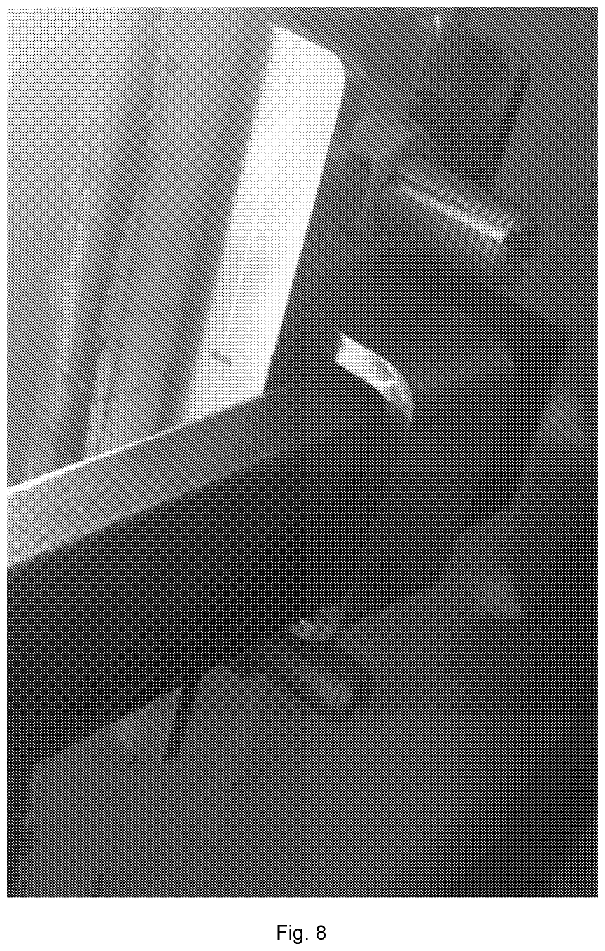

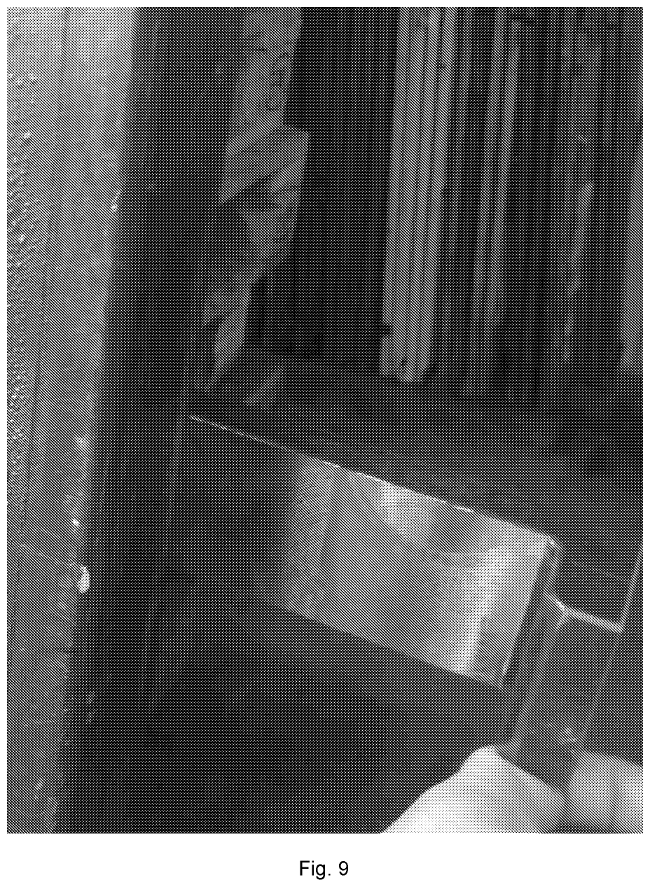

FIGS. 8 and FIG. 9 show the locking boom in FIG. 7 in an extended position.

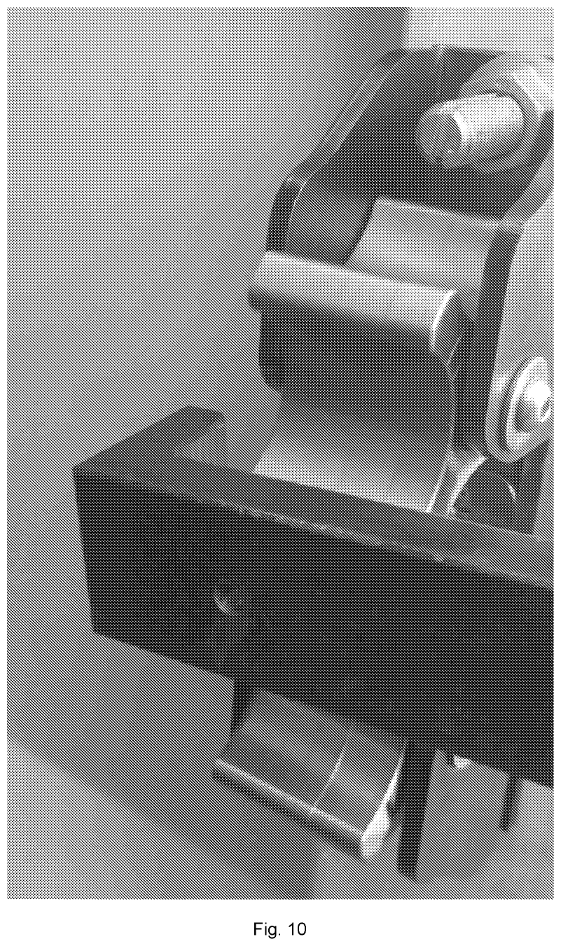

FIGS. 10, 11, 12 and 13 show a sequence of photos of the principle of the reception of the locking boom between the wheels on the locking system.

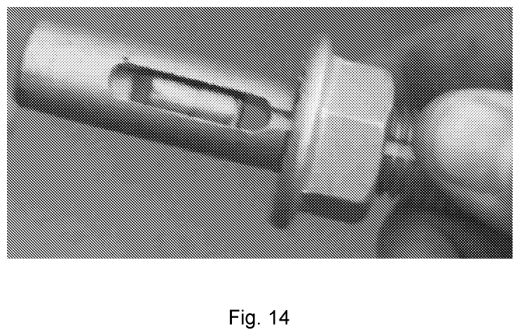

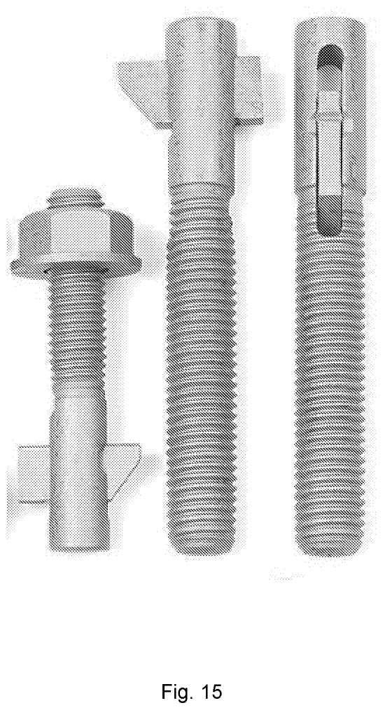

FIGS. 14 and 15 shows flip bolts that can be used for mounting of locking system and locking boom on the inside of container doors, etc.

### DETAILED DESCRIPTION

FIG. 1 shows a drawing of a locking system 1 according to the invention which is the example of the lock in FIGS. 3 to 13. The two toothed wheels 6, one on each side of the base of the lock, will, when the lock is assembled, be located so that a set of teeth 7, one on each toothed wheel, will be opposite each other. When the locking boom 8 meets two sets of teeth 7, the toothed wheels 6 will be able to rotate as the locking boom 8 and the base of the locking system are moved towards each other. The locking boom will easily move into the hollow that is formed by two sets of teeth on the toothed wheels 6 and can be locked in position by means of an arresting device that can be pushed down between the teeth 7 of the toothed wheels and the base of the locking system, whereby the arresting device will be able to hinder the rotation of the toothed wheels 6. The locking boom 8 is locked in position between the base of the locking system and the teeth 7 of the toothed wheels.

FIG. 2 is a technical drawing of the parts of the locking system in FIG. 1. The parts are: toothed wheels 6, teeth of the toothed wheels 7 and a locking boom 8.

FIG. 3 shows an example of the locking system according to the invention. The example is the same as in FIG. 1 and FIG. 2. A lock holding device in the form of a locking washer, as can be seen clearly in FIG. 3 and FIG. 4, can fix a lock, here a cylinder lock, and an arresting device. A key (not shown) can be inserted in the cylinder from the outside and be used to change the position of the arresting device. Other types of locks, such as electrical can also be contemplated to work. Electric locks are not visible from the outside and do not require a physical key.

FIG. 4 shows the locking device in the locking system in FIG. 3. Other designs of the arresting device can be just as useful. The arresting device shown is fixed in position by means of a locking washer.

FIG. 5 shows the embodiment of FIG. 3 wherein the arresting device is in a horizontal position, so that the toothed wheels can move. There is not a locking boom located between the toothed wheels in the photo, so the toothed wheels can move totally mutually independent. It is preferred that the gripping surfaces of the teeth of the toothed wheels run along soft curves so as to make the reception of a locking boom easier.

FIG. 6 shows that the toothed wheel can rotate when the arresting device is in open position. It is shown in the photo in the way that the toothed wheels are slurred because they are in motion.

FIG. 7 shows an example of a locking boom. It must have a size that fits the spaces in the toothed wheels between the teeth of the toothed wheels when the two sets of teeth, one set on each toothed wheel, form a hollow that is suited for reception of a locking boom. The reception of the locking boom can happen easily, if the design of the teeth of the toothed wheels, for instance four on each wheel with an angle of 90 degrees between all sets of a tooth and the adjacent tooth, provides sufficiently large spaces, when one tooth on one of the toothed wheels and one tooth on the other toothed wheel are located opposite one another.

FIGS. 8 an 9 show the locking boom of FIG. 7 in retracted position in which it is ready to be received by a locking system, for instance like the one that is shown in FIGS. 1 to 4, and which is located for instance as shown here on the opposite door in a container.

FIG. 10 is a photo that shows the situation just before the locking system is to receive the locking boom. In the photo the container door is not shut so as to get sufficiently light for photographing. For the same reason the locking boom is held by the hand.

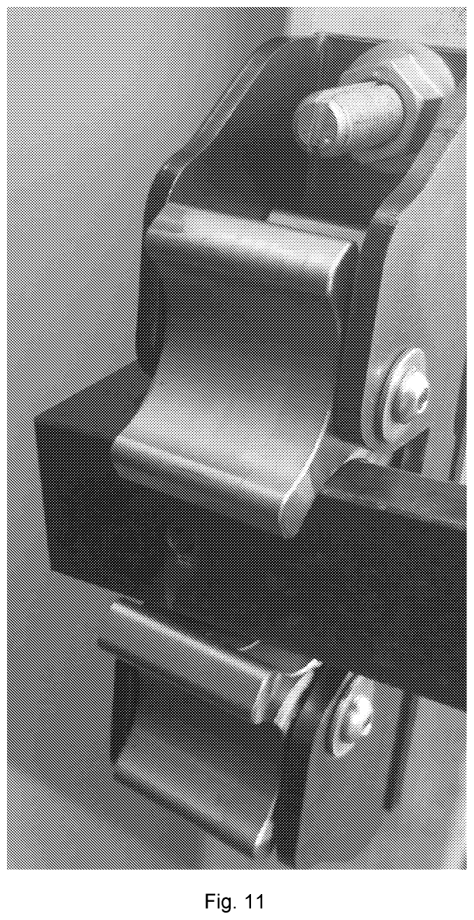

FIG. 11 shows how the locking boom is gripped in the space between two sets of adjacent teeth on the two wheels of the locking system.

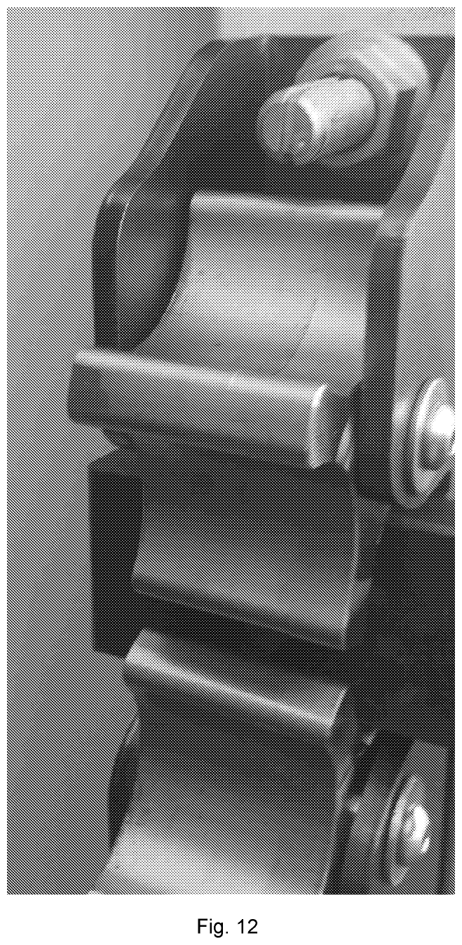

FIG. 12 shows how the locking boom abuts the back side of the container door in the locked position of the arresting device.

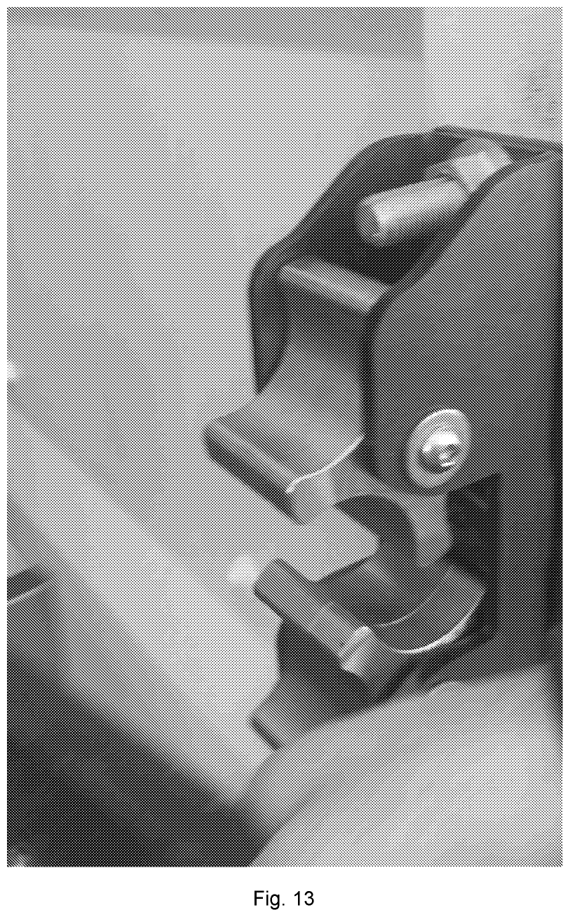

FIG. 13 shows that the locking boom can escape the grip of the wheels when the arresting device is in open position.

FIG. 14 shows an example of a bolt for mounting of the locking system and the bracket of the locking boom. It is a so called flip bolt. Other types of fastenings can also be used.

FIG. 15 shows another example of a flip bolt from another manufacturer. To the right is a threaded rod, wherein the flip part is inside the threaded rod. Centrally the flip part of the threaded rod is turned out, as it will be when the flip part is to provide counterforce to a pull in the bolt. To the left a nut is mounted. It is used for fastening a surface between the nut and the end flaps of the flip part.

The locking boom 8 is in its resting position when the locking boom 8 is in a retracted position. The lock is open in this position. In this position it is possible to pass through the created door opening without hitting the locking boom 8. In locked position flaps will be able to grip around a frame that is often present on the inner side of the locked door, and in a similar way around a frame on another door or wall edge, so that a pull in the locking system turns into a pull in for instance a whole container, as the construction, when the door is locked, becomes very strong in this way. The flaps 8 that are facing the door opening also hinders locking of the door, if the locking boom is not in an retracted position, as this flap 8 in retracted position will hinder an opposing door or wall in closing completely.

In retracted position the locking boom 8 provides a reinforcement between the surfaces of the doors to a united surface, when a locking system 1 is locked onto for instance a container door, as the locking boom 8 in this position abuts closely against for instance two door frames and is locked at one end thereof between two sets of teeth (7) on the two toothed wheels 6 on one of the door frames, and is kept in a fixed position in the other end by means of a fixed bracket that limits movement of the other end of the locking boom. The lock that is described is suited for shipping containers and is strong enough to resist a pull on one of the doors from a four wheel drive car.

As it is clear from the figures with photos and the accompanying description, it is simple to mount the locking system in for instance a shipping container.

All of the components for the locking system can appropriately be produced in a durable material such as hardened steel.

1. Locking system for mounting at a door for locking a room that is provided with at least one door, said locking system comprising a lock holder with a lock, said lock being accessible from the outside of the door, when the lock holder is mounted on the inner side of the door, and a locking boom that is adapted to be mounted at the inner side of the door or an adjacent frame and is provided to be coupled to the lock holder, whereby one end of the locking boom in the locked position of the door is made to abut the inner side of the door, and the opposite end thereof is made to abut a structure adjacent the door, such as a frame or another door, wherein the locking system further comprises at least two toothed wheels that are mounted on the lock holder and are provided to be able to rotate around mutually parallel axes and also have space between two sets of teeth on said at least two toothed wheels for locking said locking boom, and that the lock is further provided to be mounted from the inside and is connected to an arresting device that can engage in the movement area of the toothed wheels for rotation of the teeth on the toothed wheels, and wherein a movable part on the lock is provided to be able to rotate together with said arresting device, so that the toothed wheels can rotate in the open position of the arresting device and cannot rotate in the closed position of the arresting device so that a pull on said door or frame can be transferred to the locking boom in the locked position.

2. Locking system according to claim 1, wherein the teeth of said at least two toothed wheels have a concave shape in the longitudinal direction with the row of teeth on each toothed wheel on the surfaces that face adjacent teeth.

3. Locking system according to claim 1, wherein said at least two wheels can be mounted on top of each other on a reinforced door edge or frame.

4. Locking system according to claim 1, wherein the lock is a cylinder lock.

5. Locking system according to claim 4, wherein the cylinder lock is mounted centrally and generally perpendicular to the plane in which the lock holder extends.

6. Locking system according to claim 1, wherein the locking boom is designed with end flaps that are provided to reach around a frame edge on the inside of the door or frame of the adjacent frame or the other door.

7. Locking system according to claim 1, wherein the locking boom is shaped as an elongated U-profile.

8. Locking system according to claim 1, wherein the locking system comprises a bracket for one or more of said toothed wheels, which bracket can be mounted by means of flip bolts.

9. Locking system according to claim 1, wherein a bracket for the locking boom on the opposite door or frame can be mounted with flip bolts.

10. Use of a locking system as claimed in claim 1 for locking of transportable containers including shipping containers.

11. Locking system according to claim 2, wherein said at least two wheels can be mounted on top of each other on a reinforced door edge or frame.

12. Locking system according to claim 2, wherein the lock is a cylinder lock.

13. Locking system according to claim 3, wherein the lock is a cylinder lock.

14. Locking system according to claim 2, wherein the locking boom is designed with end flaps that are provided to reach around a frame edge on the inside of the door or frame of the adjacent frame or the other door.

15. Locking system according to claim 3, wherein the locking boom is designed with end flaps that are provided to reach around a frame edge on the inside of the door or frame of the adjacent frame or the other door.

16. Locking system according to claim 4, wherein the locking boom is designed with end flaps that are provided to reach around a frame edge on the inside of the door or frame of the adjacent frame or the other door.

17. Locking system according to claim 5, wherein the locking boom is designed with end flaps that are provided to reach around a frame edge on the inside of the door or frame of the adjacent frame or the other door.

18. Locking system according to claim 2, wherein the locking boom is shaped as an elongated U-profile.

19. Locking system according to claim 3, wherein the locking boom is shaped as an elongated U-profile.

20. Locking system according to claim 4, wherein the locking boom is shaped as an elongated U-profile.
